(19) United States
(12) Patent Application Publication
(10) Pub. No.: US 2026/0195244 A1
(43) Pub. Date: Jul. 9, 2026

(54) TESTING DECLARATIVE AGENT CODE USING SIMULATED SCRIPTS WITH TAGS

(71) Applicant: Sierra Technologies, Inc., San Francisco, CA (US)

(72) Inventors: Arya Asemanfar, San Francisco, CA (US); Mihai Parparita, Cupertino, CA (US); Pedram Razavi, San Francisco, CA (US); Julie Christina Tung, Los Altos, CA (US)

(21) Appl. No.: 19/013,778

(22) Filed: Jan. 8, 2025

(51) Int. Cl. G06F 11/3668

(52) U.S. Cl. CPC G06F 11/3672

(57) ABSTRACT

A declarative agent service generates a set of scripts that simulate a user input in a conversation between an agent and the user and runs agent code on the set of scripts to generate a set of responses corresponding to the set of scripts. The service identifies a set of resulting tags based on at least the set of responses and inserts the set of resulting tags in the set of scripts. The service may compare the set of resulting tags with a set of pre-determined tags. In response to determining that at least one of the one or more required tags is not identified in the set of resulting tags or at least one of the one or more prohibited tags is identified in the set of resulting tags, the service may determine that the agent code includes an error and modify the agent code to correct the error.

### TECHNICAL FIELD

The disclosure generally relates to the field of artificial intelligence, and more specifically relates to testing a declarative agent code using simulated scripts.

### BACKGROUND

Agents are software that coordinate sequences of interactions with AI (artificial intelligence), such as LLMs (large language models) and external software systems. A declarative agent service runs agent code to generate responses to user inputs. The agent code for a declarative agent service needs to evolve continuously to meet user expectations, keep up with technological advancements, and adapt to changing requirements. While updating the agent code is essential for improving functionality and user experience, it can also introduce unintended issues. These challenges often arise from the complexity of integrating new features, modifying existing ones, or adapting to new platforms. For example, existing functionality may break as unintended side effects of the updates, causing previously smooth workflows to malfunction. There is also the risk of unintended behavior, such as incorrect or inappropriate responses due to untested edge cases. Additionally, updates to machine learning models can lead to degraded performance if the training data is inadequate or biased. Scalability issues might surface when new features strain the system under high demand, and security vulnerabilities could be introduced if updates fail to protect sensitive user data. Without comprehensive testing, hidden bugs or regressions may only become apparent after deployment, affecting users in real-world scenarios. To mitigate these risks, testing, monitoring, and controlled rollout strategies for deploying and updating agent code are needed.

### SUMMARY

Systems and methods are disclosed herein that tests agent code using simulated scripts with tags. A declarative agent service generates a set of scripts that simulate a user input in a conversation between an agent and the user and runs agent code on the set of scripts to generate a set of responses corresponding to the set of scripts. The service identifies a set of resulting tags based on at least the set of responses and inserts the set of resulting tags in the set of scripts. The service may compare the set of resulting tags with a set of pre-determined tags. In response to determining that at least one of the one or more required tags is not identified in the set of resulting tags or at least one of the one or more prohibited tags is identified in the set of resulting tags, the service may determine that the agent code includes an error and modify the agent code to correct the error.

By systematically simulating user interactions and analyzing the agent's responses, the method provides a structured and comprehensive approach to evaluate the agent code. The method tests the agent code against a wide variety of user inputs, including both typical use cases and edge cases. By simulating real-world conversations, it mimics the complexity and unpredictability of actual user interactions. The inclusion of tags, such as required tags, prohibited tags, and tag hierarchies, provides a data-driven way to analyze the agent code. These tags serve as a detailed record of how the agent interprets user inputs and generate responses. By comparing the resulting tags with pre-determined tags, the method can pinpoint exactly where the agent code is excelling or falling short. This detailed analysis makes it easier to identify and address specific performance issues. This testing framework is valuable in large-scale or enterprise declarative agent service systems, where maintaining consistent and high-quality responses is crucial. It helps ensure that updates to the agent code do not introduce regressions or degrade performance, providing a reliable mechanism for continuous improvement.

### BRIEF DESCRIPTION OF DRAWINGS

The disclosed embodiments have other advantages and features which will be more readily apparent from the detailed description, the appended claims, and the accompanying figures (or drawings). A brief introduction of the figures is below.

FIG. 1 illustrates one embodiment of a system environment for implementing a declarative agent service.

FIG. 2 illustrates one embodiment of modules of the declarative agent service.

FIG. 3 is a flowchart for a method of testing agent code using simulated scripts with tags.

FIG. 4 is a block diagram illustrating components of an example machine able to read instructions from a machine-readable medium and execute them in a processor (or controller).

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

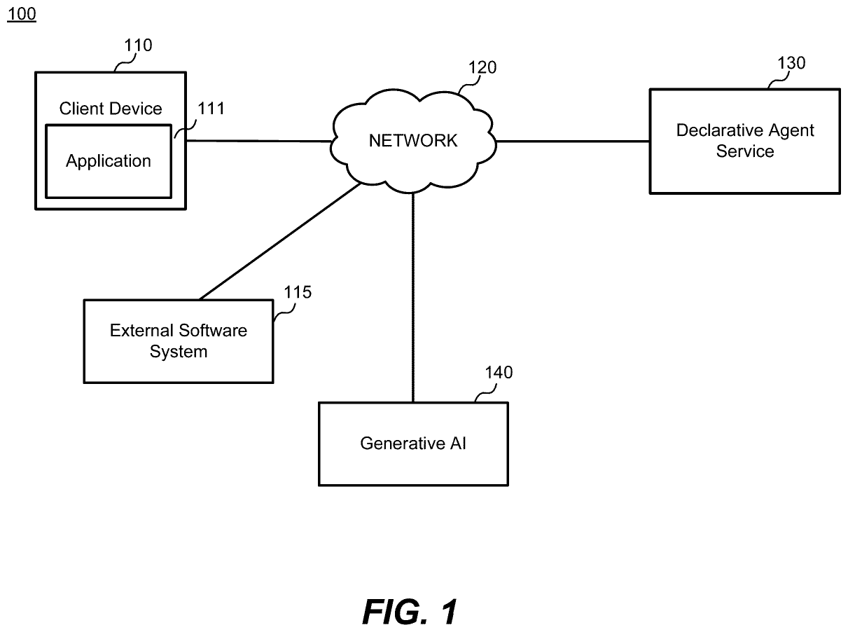

Figure (FIG.) 1 illustrates one embodiment of a system environment for implementing a declarative agent service. As depicted in FIG. 1, declarative agent service environment 100 includes client device 110. While policy enforcement application 111 is only depicted with respect to one client device 110, this is for convenience only, and many number of client devices may be interacting with declarative agent service 130. Client device 110 may be any device operated by an end-user having a user interface, such as a smartphone, a laptop, a personal computer, a wearable (e.g., smart watch), a kiosk, or any other electronic device capable of interfacing between a user and declarative agent service 130.

Declarative agent service 130 may be accessed by client device 110 using application 111. Application 111 may be an application dedicated to activities of declarative agent service 130 (e.g., an installed software package downloaded from declarative agent service 130 or an external repository such as an app store, or installed using other means such as a hard disk). Alternatively or additionally, application 111 may be a browser through which declarative agent service 130's functionality may be accessed (e.g., directly, or indirectly through an embedded portal in a website of third party company).

External software system 115 may be a software system of, e.g., a platform that utilizes declarative agent service 130. External software system 115 may require human intervention or may be utilized without a human in the loop, and may be configured to provide functionality, such as chatbot (interchangeably used with “chat automation system”) functionality to users of the platform. Client device 110 may be used by an entity controlling external software system 115 to communicate to declarative agent service 130 information sufficient to deploy guardrails on LLM outputs and/or may be used by end-users interacting with external software system 115 to resolve and otherwise chat through an issue.

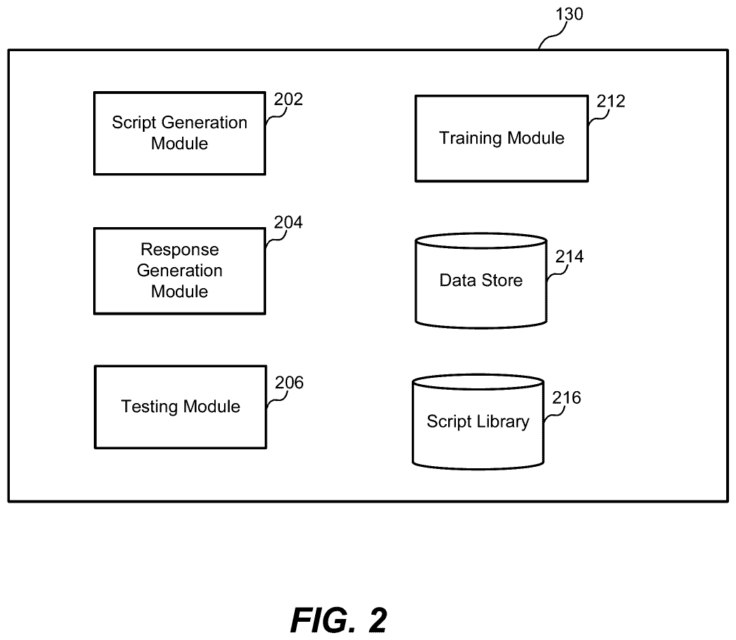

Declarative agent service 130 is used by client devices 110 and/or external software system 115 to provide a chat interface that addresses inquiries by users or by the platform of an external software system. Declarative agent service 130 is instantiated on one or more servers, accessible by way of network 120. Some or all functionality of declarative agent service 130 described herein may be distributed or fully performed by application 111 on a client device, or vice versa. Where reference is made herein to activity performed by application 111, it equally applies that declarative agent service 130 may perform that activity off of the client device, and vice versa. Declarative agent service 130 may be provided as a software development kit (SDK) to a client device or external software service to enable these entities to build the functionality of declarative agent service 130 on-premises. The SDK may export an API such that 3rd parties (e.g., client devices or external software services) can specify their agents. Agent code using the SDK API is then uploaded to declarative agent service 130, on which it can execute (and run as an agent). Further details about the operation of declarative agent service 130 are described below with reference to FIG. 2.

Generative AI 140 may be part of declarative agent service 130 or may be a third-party provider (e.g., OpenAI) that provides generative AI for processing natural language queries. Generative AI 140 may include one or many LLMs, the LLMs provided by any number of providers.

FIG. 2 illustrates one embodiment of modules of the policy enforcement service. As depicted in FIG. 2, the declarative agent service 130 includes a script generation module 202, a response generation module 204, a testing module 206, a training module 212, a data store 214, and a script library 216. These modules and databases are merely illustrative; fewer or more modules and/or databases may be used to achieve the functionality disclosed herein.

The script generation module 202 generates simulated user-agent conversation scripts that simulate real-life user-agent conversations. To generate the scripts, the script generation module 202 may receive an instruction to generate a set of scripts that simulate user's input. In some embodiments, the instruction may include a set of messages/prompts that describes a user input in a conversation between the user and the agent. For example, the set of messages/prompts may include, “Cancel my order,” “zzz@xxx. com,” “I don't have the order number,” “bright white,” and “Dwyane.” The simulated user input may include the user's intent, query, request, etc. during the conversation. In some embodiments, the instruction may include user personas, e.g., fictional profiles that represent different types of users based on their demographic, emotional, and behavioral characteristics.

In one implementation, the script generation module 202 may define a set of personas that reflect the diversity of the target users. For instance, an e-commerce agent may include personas like: “Frustrated user: Frustrated and impatient, demanding immediate solutions;” “Confused new user: Unfamiliar with the system, requiring step-by-step guidance;” and “Expert user: Knowledgeable and expecting concise, efficient responses.” Each persona may include emotional variants to simulate different user states. For example, a user may approach a query neutrally (“What are the steps to reset my password?”), positively (“Thanks for your help, how do I reset my password?”), or negatively (“Why is resetting my password so complicated?”). Once personas are defined, the agent responses may be adapted to reflect the user's tone, knowledge level, and expectations. In some embodiments, the user personas, such as the user's emotional state may be specified in the instruction. The script generation module 202 may generate a prompt including the user personas, e.g., characteristics of the user, and input the prompt to an LLM to generate simulated scripts that reflect the characteristics of the user. The simulated scripts may simulate the persona-specific scenarios by combining personas with the set of messages/prompts in the instruction, e.g., user intents, conversation flows. For instance, an instruction may specify an angry user requesting a refund for a defective product, and the corresponding simulated user inputs may include:
User: “This product is defective! I want a refund now!”
User: “I don't have it! Why do I even need it?”
User: “This is a waste of time.”

The script generation module 202 may apply machine learning models, such as large language models (LLMs) to the instruction to generate the set of scripts. In some implementations, the LLMs may be pre-trained LLMs with transformer-based architectures. The pre-trained LLMs may be trained on vast datasets and understand context, grammar, and conversational nuances. The script generation module 202 may fine-tune the pre-trained LLMs for the specific domain where the agent will operate. For instance, if the agent is designed for customer service in the healthcare industry, the pre-trained LLMs may be fine-tuned using a dataset that includes common patient queries, medical terminology, and conversational patterns unique to healthcare. The LLMs output simulated scripts based on the instruction. In some embodiments, the simulated scripts may include a set of user inputs each corresponding to a message/prompt included in the instruction. For example, for the message/prompt “zzz@xxx. com,” the corresponding simulated user input may be “My account is zzz@xxx. com.”

In some implementations, the instruction may include a set of pre-determined tags associated with the simulated scripts. A tag may be used to identify a user intent at a point in the conversation. In some examples, the tag may indicate a conversational state that identifies an operating mode for the agent. For example, the tags may include “cancel order,” “new order,” “order status,” “delivery schedule,” and the like. The pre-determined tags may include required tags and/or prohibited tags. Required tags may refer to the operating modes that are expected in the agent responses and the prohibited tags may refer to the operation modes that are not allowed in the agent responses. In some implementations, the tags may include a hierarchical structure, allowing the agent to break down a broad concept into more specific actions or details. In one instance, the tag “cancel order” may include a hierarchical structure, such as, a first-level tag:
“cancel order;” a second-level tag: “order number identified” (this tag identifies which specific order the user wants to cancel. The order number or some other identifier may be provided here); a third-level tag: “remedy for order,” and fourth-level tags: “refund,” “exchange,” “credit,” etc. In some embodiments, the required/prohibited tags may be explicitly included in the instruction, e.g., included in the set of messages/prompts; alternatively, the tags may be determined based on the simulated user inputs in the set of scripts.

In some embodiments, the instruction may include a prompt specified in natural languages. For example, a prompt may be “Simulate a conversation where a frustrated customer is requesting a refund due to a defective product.” In some embodiments, the instruction may include edge cases and variants. These are scenarios where user behavior deviates from the norm, such as ambiguous queries, typos, or emotionally charged inputs. For example, the instruction may specify a prompt that includes a request to add spelling errors, provide incomplete information, and the like in the generated simulated scripts, and the corresponding scripts may be “Trak my pakage plz,” and “It's not here yet.” The script generation module 202 generates a prompt based on the instruction and applies the LLMs to the generated prompt to receive simulated scripts, e.g., a set of user inputs.

The response generation module 204 receives the set of scripts and runs the agent code on the set of scripts to generate a set of responses corresponding to the simulated user inputs. The response generation module 204 applies agent code to identify the user's intent, request, query, or task included in the user inputs. In some embodiments, the response generation module 204 may run the agent code on the set of scripts to identify one or more conversational states that corresponding to operating modes of the agent, e.g., tags. The response generation module 204 may determine a set of resulting tags that may be used to generate responses to the simulated scripts. In some implementations, the response generation module 204 may map the user's text to a predefined category of actions or responses (e.g., tags), such as “cancel order,” “order status,” etc. In some embodiments, the response generation module 204 may include a machine learning model, such as a large language model (LLM), which is trained on large datasets of labeled conversations. These datasets include numerous examples of how users express the same intent/request using different words or phrases. The LLM uses the training examples to recognize patterns and classify similar inputs into the same intent/request category (e.g., tags).

Based at least on the identified user intent/requests/tags (such as checking order status, canceling an order, or providing information), the response generation module 204 generates a response to the corresponding user input in the simulated scripts. In some implementations, the agent code may include a rule-based response generation. For instance, the agent code includes a set of predefined templates or rules to match specific intents/requests/tags. For example, if the user's intent/request is identified as “cancel order,” the agent code may generate a response template like: “Your order #{{order_number}} has been canceled, and a refund will be processed.” When generating responses, the response generation module 204 applies the agent code which substitutes the {{order_number}} placeholder with the actual order number provided by the user. In some implementations, the agent code may include decision trees or flowcharts to generate a response to a user input/tag, and the decision trees or flowcharts use a set of rules for how to proceed based on the user's previous inputs. For example, if the user mentions a product they want to return, the generated responses may first ask for the order number, then offer the options for exchange or refund based on the next steps. In some implementations, the agent code may include/activate a machine learning model, such as a LLM to generate a response to the user input.

The testing module 206 evaluate the agent code for generating the responses based on a set of resulting tags identified from the generated response. The testing module 206 receives the simulated user inputs from the script generation module 202 and determines a set of pre-determined tags included in the simulated scripts. Each tag may identify a user intent at a point in the conversation, and/or a conversational state that identifies an operating mode for the agent. In some implementations, the set of pre-determined tags may be specified in the instruction for generating the simulated scripts. For example, an instruction may include a set of pre-determined tags with a set of messages/prompts. The set of pre-determined tags may include required tags, such as, “cancel order,” “order number,” etc., and/or prohibited tags, such as, “delivery schedule,” “program installation,” etc. A pre-determine tag may be associated with a respective message/prompt. For example, a tag “cancel order” may be associated with a message “Cancel my order.” A location in the set of simulated scripts may correspond to a point in the conversation, and the corresponding pre-determined tag may be identified/determined to at the location in the simulated scripts. For example, the simulated scripts may include a user input “I would like to cancel my order.” The testing module 206 may identify that a pre-determined tag “cancel order” is associated with this simulated user input. In some implementations, the set of per-determined tags may be not explicitly included in the instruction for generating the simulated scripts, and the testing module 206 may identify the set of pre-determined tags based on the set of simulated scripts.

The testing module 206 receives the generated responses from the response generation module 204 and identifies a set of resulting tags based on at least the generated responses. In some implementations, the testing module 206 may combine the simulated scripts (e.g., user inputs) and the generated response to form a full set of conversation scripts and identify the set of resulting tags. In some embodiments, the response generation module 204 identifies the set of resulting tags by running the agent code on the set of simulated scripts and uses the set of resulting tags to generate the responses. In this case, the testing module 206 may receive the set of resulting tags with the generated responses and retrieve the set of resulting tags for testing and evaluating the agent code.

In some implementations, the testing module 206 may use a rule-based tag extraction to identify the set of resulting tags from the generated responses. The testing module 206 may use predefined patterns, keywords, or rules to map the generated responses to corresponding tags. For example, the testing module 206 may generate a mapping of keywords or phrases to each tag. For instance, the tag “order status” may be associated with terms such as “track,” “status,” or “delivery.” Based on the mappings, the testing module 206 may scan the responses for these keywords, e.g., by using regular expressions or simple string matching. If a keyword is found, its corresponding tag is assigned to the respective response of the set of generated responses.

In some implementations, the testing module 206 may apply a machine learning model to identify the set of resulting tags from at least the generated responses. For example, the testing module 206 may use LLMs to classify responses into a set of resulting tags. To train the machine learning model, a training dataset that contains labeled examples of responses and their corresponding tags may be generated. For example, a response like “Your order has been placed successfully” is labeled with the tag “Order status.” This dataset is then used to train the machine learning model, such as a logistic regression model, decision tree, or more advanced transformer-based models and the like. The testing module 206 applies the trained machine learning model to the generated responses and/or the simulated scripts and receive output from trained machine learning model which includes a set of resulting tags.

In some embodiments, the testing module 206 may identify a location in the simulated script for each resulting tag. The location in the simulated scripts may be associated with a point in the conversation that corresponds to the user intent and/or an operating mode identified by the corresponding tag. In some implementations, the testing module 206 may insert each of the set of resulting tags at the respective location in the set of simulated scripts. In one example, the testing module 206 combines the set of simulated script with the set of generated responses as a set of simulated conversation scripts. The testing module 206 identifies the set of resulting tags and insert the resulting tags into conversation scripts at the respective locations. The example may be shown as follows:
Agent: “How can I help you today?”
User: “I would like to cancel my order.”
[Tag]: cancel order.
Agent: “Could you please provide me with your order number and email address?”
User: zzz@xxx. com.
[Tag]: account identified.
Agent: “Thank you for providing your email address. To proceed with the cancellation, I also need your order number. Could you please provide that?”
User: “I don't have the order number.”
[Tag]: order number not identified.

The testing module 206 compares the set of resulting tags with the set of pre-determined tags and determines whether the set of resulting tags match with the set of pre-determined tags. The testing module 206 may evaluate the generated responses based on the comparison result. For example, the testing module 206 may determine whether the set of resulting tags include the required tags and/or prohibited tags in the set of pre-determined tags. In some examples, the testing module 206 may set criteria for the generated responses, e.g., based on the number of matched/mismatched tags. In one example, the criteria may require that each of the set of resulting tags matches with each of the set of pre-determined tags. In another example, the testing module 206 may determine the agent code for generating the responses includes an error when at least one of the one or more required tags is not identified in the set of resulting tags or at least one of the one or more prohibited tags is identified in the set of resulting tags. In yet another example, the testing module 206 may allow a threshold number or percentage of mismatched tags. In still another example, the testing module 206 may compare the locations of the resulting tags to the locations of the pre-determined tags. For instance, the testing module 206 may determine that a resulting tag matches a required tag of the pre-determined tags, but a location of the resulting tag is different from a location of the required tag, and the testing module 206 may determine the corresponding agent code for generating the response associated with this tag includes an error. In some implementations, the testing module 206 may identify the set of resulting tags matches with the set of pre-determined tags, the agent code for generating the responses does not include error and pass the test. In some implementations, the testing module 206 may identify one or more errors in the agent code.

The model training module 212 receives the comparison result/testing result and modify the agent code to correct the errors based on the mismatched tags, for example, mismatched required tags or prohibited tags. For rule-based agent code, the model training module 212 may update keyword matching rules based on the testing result. In one instance, the resulting tags miss one required tag, and the model training module 212 may expand keyword lists to include synonyms and variations observed in historical conversations. The model training module 212 may refine the decision-making logic by incorporating conversation context. For instance, incorporating prior user actions or conversational history to generate responses that are more relevant and avoid irrelevant or redundant information. The model training module 212 may update response templates to make it easier to identify tags while avoiding unnecessary content that may trigger incorrect tags.

For agent code that uses machine learning models, the model training module 212 may use the testing result, simulated scripts, generated response, and the agent code as feedback to update the training dataset. For example, the model training module 212 may update labeled examples, add new labeled examples, balance underrepresented tags, or augment existing datasets to cover variations in user intents. The model training module 212 may upgrade the model architecture and fine-tune the models with domain-specific data, context, user intent, etc. In some implementations, the model training module 212 may incorporate a feedback loop where mismatched resulting tags are analyzed and used to retrain or adjust the model. In some examples, a human operator may review the testing result, the mismatched resulting tags, and/or the conversation scripts, and identifies errors in the agent code. The human operator may modify labels of the training examples and/or modify the agent code. A human operator may identify cases where the model fails to meet expectations, such as generating incorrect or incomplete tags. These cases can then be added to the training dataset with proper corrections, allowing the model to learn from its mistakes. In some cases, a human operator may suspend a testing when an error of the agent code is identified. The human operator may adjust the agent code during the run-time and resume/repeat the testing.

The model training module 212 may apply an iterative process to train a machine-learning model whereby the model training module 212 updates parameter values of machine-learning models based on each of the set of training examples. The training examples may be processed together, individually, or in batches. To train a machine-learning model based on a training example, the model training module 212 applies the machine-learning model to the input data in the training example to generate an output based on a current set of parameter values. The model training module 212 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross-entropy loss function. The model training module 212 updates the set of parameters for the machine-learning model based on the score generated by the loss function. For example, the model training module 212 may apply gradient descent to update the set of parameters.

The declarative agent service 130 may use various machine learning models in the process of testing the agent code. In one implementation, the machine learning models may be trained on natural language processing tasks. The trained machine learning model may analyze vast amounts of historical user-agent conversations to identify patterns and correlations between specific phrases, contexts, sentiments, user intent, operation mode of the agents, and the like. By learning from labeled datasets, the trained machine learning models may automatically generate simulated scripts based on natural language instructions, identify tags associated with the simulated scripts, and/or compare resulting tags and pre-determined tags, and the like. In some embodiments, the machine learning models may be used to identify errors in the agent coded based on the testing result (e.g., comparison of the resulting tags and pre-determined tags). By continuously learning from new data and adjusting based on feedback, the machine model may optimize its decision-making process. In some embodiments, the machine learning models may be updated/retrained regularly based on new data and feedback from testing results.

The data store 214 stores data used by the declarative agent service 130. For example, the data store 214 stores user data, previous conversation, etc. for use by the declarative agent service 130. The data store 214 also stores trained machine-learning models trained by the model training module 212. For example, the data store 214 may store the set of parameters for a trained machine-learning model on one or more non-transitory, computer-readable media. The data store 214 uses computer-readable media to store data, and may use databases to organize the stored data.

The script library 216 stores simulated scripts that are generated for testing the agent code. In some implementations, the simulated scripts may include simulated user inputs based on the messages/prompts in the instructions designed for testing the agent code. In some implementations, the simulate scripts may be conversational scripts that include both simulated user inputs and the corresponding responses generated by the agent. In some embodiments, the script library 216 stores a set of pre-determined tags associated with the respective simulated scripts. In some embodiments, the script library 216 may include a database of tags which stores information of the tags, such as definition, categories, hierarchical structures and the like. In some embodiments, the script library 216 may store a mapping between the tags and the key words, strings, phrases, etc., and the mapping may be used to identify tags included in the simulated scripts and/or generated responses.

### Testing Agent Code Using Simulated Scripts With Tags

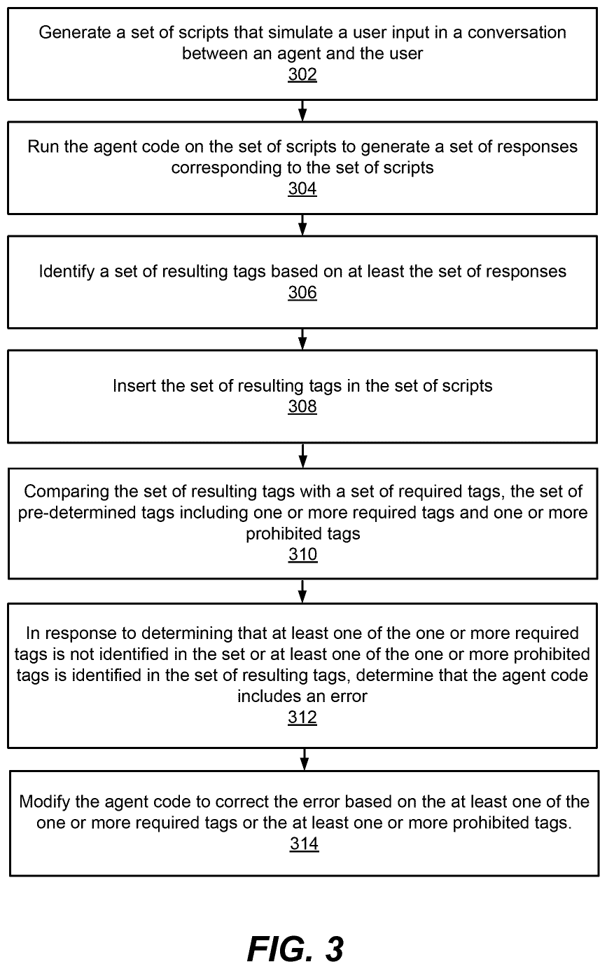

FIG. 3 is a flowchart for a method of testing agent code using simulated scripts with tags. Alternative embodiments may include more, fewer, or different steps from those illustrated in FIG. 3, and the steps may be performed in a different order from that illustrated in FIG. 3. These steps may be performed by a declarative agent service 130. In some embodiments, each of these steps may be performed automatically by the declarative agent service 130 without human intervention. In some embodiments, a human operator may perform one or more of the steps.

The declarative agent service 130 generates 302 a set of scripts that simulate a user input in a conversation between an agent and the user. The declarative agent service 130 receives an instruction to generate simulated scripts. The instruction may include a set of message/prompts for generating the simulated scripts. In some embodiments, the instruction may include user personas, such as characteristics, emotions, etc. The declarative agent service 130 may generate a prompt requesting the simulated scripts to reflect the user personas.

The declarative agent service 130 runs 304 the agent code on the set of scripts generate a set of responses corresponding to the set of scripts, and identifies 306 a set of resulting tags based on at least the set of responses. Each tag may identify a user intent at a point in the conversation. In some embodiments, a tag is associated with a conversational state that identifies an operating mode for the agent. In some embodiments, the set of resulting tags includes a hierarchical structure. The declarative agent service 130 may insert 308 the set of resulting tags in the set of scripts. Each tag may be inserted at a location in the set of scripts that corresponds to the respective point in the conversation. The declarative agent service 130 compares 310 the set of resulting tags with a set of pre-determined tags. The set of pre-determined tags may include one or more required tags and one or more prohibited tags. In response to determining that at least one of the one or more required tags is not identified in the set of resulting tags or at least one of the one or more prohibited tags is identified in the set of resulting tags, the declarative agent service 130 determines 312 that the agent code includes an error. In some embodiments, a resulting tag corresponding to a required tag is not located at a pre-determined location of the required tag in the set of scripts, the declarative agent service 130 may determine the agent code associated with this resulting tag includes an error. In some embodiments, when the declarative agent service 130 determines the agent code includes an error, the declarative agent service 130 may modify 314 the agent code to correct the error based on the at least one of the one or more required tags or the at least one of the one or more prohibited tags.

### Computing Machine Architecture

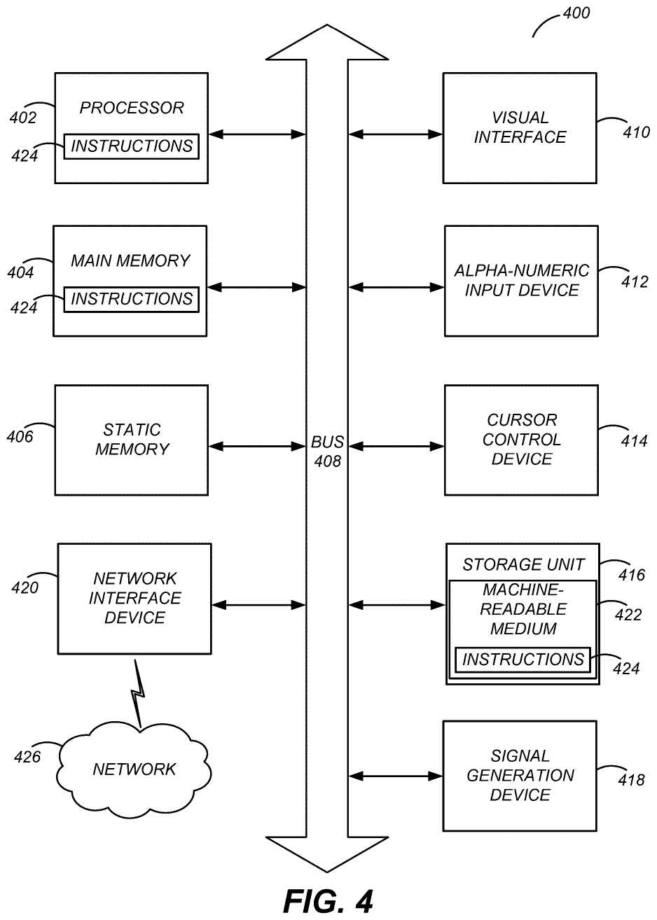

FIG. 4 is a block diagram illustrating components of an example machine able to read instructions from a machine-readable medium and execute them in a processor (or controller). Specifically, FIG. 4 shows a diagrammatic representation of a machine in the example form of a computer system 400 within which program code (e.g., software) for causing the machine to perform any one or more of the methodologies discussed herein may be executed. The program code may be comprised of instructions 424 executable by one or more processors 402. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 400 includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include visual display interface 410. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 410 may include or may interface with a touch enabled screen. The computer system 400 may also include alphanumeric input device 412 (e.g., a keyboard or touch screen keyboard), a cursor control device 414 (e.g., a mouse, a trackball, a joystick, a motion sensor, or other pointing instrument), a storage unit 416, a signal generation device 418 (e.g., a speaker), and a network interface device 420, which also are configured to communicate via the bus 408.

The storage unit 416 includes a machine-readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor's cache memory) during execution thereof by the computer system 400, the main memory 404 and the processor 402 also constituting machine-readable media. The instructions 424 (e.g., software) may be transmitted or received over a network 426 via the network interface device 420.

While machine-readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for reconciling configuration settings for imported resources through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method of testing agent code, comprising:
generating a set of scripts that simulate a user input in a conversation between an agent and the user;
running the agent code on the set of scripts to generate a set of responses corresponding to the set of scripts;
identifying a set of resulting tags based on at least the set of responses, each tag identifying a user intent at a point in the conversation;
inserting the set of resulting tags in the set of scripts, each tag inserted at a location in the set of scripts that corresponds to the respective point in the conversation;
comparing the set of resulting tags with a set of pre-determined tags, the set of pre-determined tags including one or more required tags and one or more prohibited tags;
in response to determining that at least one of the one or more required tags is not identified in the set of resulting tags or at least one of the one or more prohibited tags is identified in the set of resulting tags, determining that the agent code includes an error; and
modifying the agent code to correct the error based on the at least one of the one or more required tags or the at least one of the one or more prohibited tags.

2. The method of claim 1, wherein running the agent code on the set of scripts to generate a set of responses corresponding to the set of scripts comprises:
generating a prompt comprising a user persona describing at least characteristics of the user;
inputting the prompt to a large language model to generate a user response that reflects the characteristics of the user; and
generating the set of responses comprising the generated user response reflecting the characteristics of the user.

3. The method of claim 1, wherein at least one tag is associated with a conversational state that identifies an operating mode for the agent.

4. The method of claim 1, wherein the set of resulting tags includes a hierarchical structure.

5. The method of claim 1, wherein comparing the set of resulting tags with a set of pre-determined tags comprises:
comparing each of the set of resulting tags to the set of pre-determined tags; and
determining whether each of the set of resulting tags matches with one of the one or more required tags.

6. The method of claim 1, wherein comparing the set of resulting tags with a set of pre-determined tags:
comparing a location of each of the set of resulting tags to a location of a required tag corresponding to the respective resulting tag; and
responsive to determining that the location of at least one resulting tag is different from the location of the corresponding required tag, determining that the agent code includes an error associated with the at least one resulting tag.

7. The method of claim 1, further comprising:
iteratively testing the agent code by running the modified agent code on the set of scripts.

8. A non-transitory computer readable storage medium comprising stored program code, the program code comprising instructions, the instructions when executed causes a processor system to:
generate a set of scripts that simulate a user input in a conversation between an agent and the user;
run the agent code on the set of scripts to generate a set of responses corresponding to the set of scripts;
identify a set of resulting tags based on at least the set of responses, each tag identifying a user intent at a point in the conversation;
insert the set of resulting tags in the set of scripts, each tag inserted at a location in the set of scripts that corresponds to the respective point in the conversation;
compare the set of resulting tags with a set of pre-determined tags, the set of pre-determined tags including one or more required tags and one or more prohibited tags;
in response to determining that at least one of the one or more required tags is not identified in the set of resulting tags or at least one of the one or more prohibited tags is identified in the set of resulting tags, determine that the agent code includes an error; and
modify the agent code to correct the error based on the at least one of the one or more required tags or the at least one of the one or more prohibited tags.

9. The non-transitory computer readable storage medium of claim 8, wherein the instructions to run the agent code on the set of scripts to generate a set of responses corresponding to the set of scripts further cause the processor system to:
generate a prompt comprising a user persona describing at least characteristics of the user;
input the prompt to a large language model to generate a user response that reflects the characteristics of the user; and
generate the set of responses comprising the generated user response reflecting the characteristics of the user.

10. The non-transitory computer readable storage medium of claim 8, wherein at least one tag is associated with a conversational state that identifies an operating mode for the agent.

11. The non-transitory computer readable storage medium of claim 8, wherein the set of resulting tags includes a hierarchical structure.

12. The non-transitory computer readable storage medium of claim 8, wherein the instructions to compare the set of resulting tags with a set of pre-determined tags further cause the processor system to:
compare each of the set of resulting tags to the set of pre-determined tags; and
determine whether each of the set of resulting tags matches with one of the one or more required tags.

13. The non-transitory computer readable storage medium of claim 8, wherein the instructions to compare the set of resulting tags with a set of pre-determined tags further cause the processor system to:
compare a location of each of the set of resulting tags to a location of a required tag corresponding to the respective resulting tag; and
responsive to determining that the location of at least one resulting tag is different from the location of the corresponding required tag, determine that the agent code includes an error associated with the at least one resulting tag.

14. The non-transitory computer readable storage medium of claim 8, wherein the instructions further cause the processor system to:
iteratively test the agent code by running the modified agent code on the set of scripts.

15. A computer system comprising:
a processor; and
a non-transitory computer-readable storage medium storing instructions that, when executed by a processor, cause the processor to:
generate a set of scripts that simulate a user input in a conversation between an agent and the user;
run agent code on the set of scripts to generate a set of responses corresponding to the set of scripts;
identify a set of resulting tags based on at least the set of responses, each tag identifying a user intent at a point in the conversation;
insert the set of resulting tags in the set of scripts, each tag inserted at a location in the set of scripts that corresponds to the respective point in the conversation;
compare the set of resulting tags with a set of pre-determined tags, the set of pre-determined tags including one or more required tags and one or more prohibited tags;
in response to determining that at least one of the one or more required tags is not identified in the set of resulting tags or at least one of the one or more prohibited tags is identified in the set of resulting tags, determine that the agent code includes an error; and
modify the agent code to correct the error based on the at least one of the one or more required tags or the at least one of the one or more prohibited tags.

16. The computer system of claim 15, wherein the instructions to run the agent code on the set of scripts to generate a set of responses corresponding to the set of scripts further cause the processor to:
generate a prompt comprising a user persona describing at least characteristics of the user;
input the prompt to a large language model to generate a user response that reflects the characteristics of the user; and
generate the set of responses comprising the generated user response reflecting the characteristics of the user.

17. The computer system of claim 15, wherein at least one tag is associated with a conversational state that identifies an operating mode for the agent.

18. The computer system of claim 15, wherein the set of resulting tags includes a hierarchical structure.

19. The computer system of claim 15, wherein the instructions to compare the set of resulting tags with a set of pre-determined tags further cause the processor to:
compare each of the set of resulting tags to the set of pre-determined tags; and
determine whether each of the set of resulting tags matches with one of the one or more required tags.

20. The computer system of claim 15, wherein the instructions to compare the set of resulting tags with a set of pre-determined tags further cause the processor to:
compare a location of each of the set of resulting tags to a location of a required tag corresponding to the respective resulting tag; and
responsive to determining that the location of at least one resulting tag is different from the location of the corresponding required tag, determine that the agent code includes an error associated with the at least one resulting tag.
